(19) United States
(12) Patent Application Publication
(10) Pub. No.: US 2009/0249980 A1
(43) Pub. Date: Oct. 8, 2009

(54) Cementitious composition

(76) Inventor: Bo H. Gimvang, South Daytona, FL (US)

Correspondence Address: ROGERS TOWERS, P.A., 1301 RIVERPLACE BOULEVARD, SUITE 1500, JACKSONVILLE, FL, 32207, US

(21) Appl. No.: 12/381,830

(22) Filed: Mar. 17, 2009

Related U.S. Application Data
(60) Provisional application No. 61/037,286, filed on Mar. 17, 2008.

(51) Int. Cl. C04B 12/02

(52) U.S. Cl. 106/690

(57) ABSTRACT

A cementitious composition being a mixture of mono ammonium hydrogen phosphate, magnesium oxide, silicate fibers and water. For the dry components, approximately 40 to 90 wt. percent magnesium oxide, approximately 30 to 5 wt. percent mono ammonium hydrogen phosphate and approximately 30 to 5 wt. percent silicate fibers are mixed.

This application claims the benefit of U.S. Provisional Patent Application Ser. No. 61/037,286, filed Mar. 17, 2008.

### BACKGROUND OF THE INVENTION

This invention relates generally to the field of cementitious or binder compositions similar in characteristics, properties and applications to Portland cement or other cementitious compositions, the composition being useful as a binding agent in stucco, mortar, concrete, grout and the like.

### SUMMARY OF THE INVENTION

The composition is a cementitious or ceramic cement composition useful as a component in stucco, mortar, concrete, grout or the like, typically acting as a binder agent for aggregate material, such as sand, crushed rock, glass fibers, carbon fibers or the like.

The cementitious composition consists essentially of a mixture of mono ammonium hydrogen phosphate, magnesium oxide, silicate fibers and water. For the dry components, approximately 40 to 90 wt. percent magnesium oxide, approximately 30 to 5 wt. percent mono ammonium hydrogen phosphate and approximately 30 to 5 wt. percent silicate fibers are mixed. A suitable amount of water is added to provide a workable viscosity or consistency. A small amount of boric acid, less than approximately 1 wt. percent, may be added to retard the curing reaction. The composition may be mixed with other binders, aggregates, fibers, etc. as desired or needed to produce a stucco, mortar, concrete, grout or similar material. The composition is a substitute for and behaves in similar manner to Portland cement.

### DETAILED DESCRIPTION OF THE INVENTION

The cementitious composition consists essentially of a mixture of mono ammonium hydrogen phosphate, magnesium oxide, silicate fibers and water. For the dry components, approximately 40 to 90 wt. percent magnesium oxide, approximately 30 to 5 wt. percent mono ammonium hydrogen phosphate and approximately 30 to 5 wt. percent silicate fibers are mixed. A suitable magnesium oxide is sold under the brand names OXYMAG 120 or 180 and DB-90 BMF. The silicate fibers may be aluminum silicate or calcium silicate (wollastonite) fibers. A suitable amount of water is added to provide a workable viscosity or consistency. A representative preferable dry component mixture consists of approximately 60 wt. percent magnesium oxide, approximately 15 wt. percent mono ammonium hydrogen phosphate and approximately 25 wt. percent silicate fibers.

A small amount of boric acid, less than approximately 1.5 wt. percent, is preferably added to retard the reaction. The composition may be mixed with other binders, aggregates, fibers, etc. as desired or needed to produce a stucco, mortar, concrete, grout or similar material. The composition cures by water evaporation.

It is contemplated that certain equivalents or substitutions for certain elements set forth above may be obvious to one skilled in the art, and therefore the true scope and definition of the invention is to be as set forth in the following claims.

I claim:

1. A cementitious composition consisting essentially of water and a dry component mixture of mono ammonium hydrogen phosphate, magnesium oxide and silicate fibers.

2. The composition of claim 1, further including boric acid.

3. The composition of claim 1, said dry component mixture consisting essentially of approximately 40 to 90 wt. percent magnesium oxide, approximately 30 to 5 wt. percent mono ammonium hydrogen phosphate, and approximately 30 to 5 wt. percent silicate fibers.

4. The composition of claim 3, said silicate fibers being aluminum silicate fibers.

5. The composition of claim 3, said silicate fibers being calcium silicate fibers.

6. The composition of claim 1, said dry component mixture consisting essentially of approximately 60 wt. percent magnesium oxide, approximately 15 wt. percent mono ammonium hydrogen phosphate, and approximately 25 wt. percent silicate fibers.

7. The composition of claim 2, said dry component mixture consisting essentially of approximately 40 to 90 wt. percent magnesium oxide, approximately 30 to 5 wt. percent mono ammonium hydrogen phosphate, approximately 30 to 5 wt. percent silicate fibers, and less than approximately 1.5 wt. percent boric acid.

8. The composition of claim 7, said silicate fibers being aluminum silicate fibers.

9. The composition of claim 7, said silicate fibers being calcium silicate fibers.

10. The composition of claim 2, said dry component mixture consisting essentially of approximately 60 wt. percent magnesium oxide, approximately 15 wt. percent mono ammonium hydrogen phosphate, approximately 24 wt. percent silicate fibers, and approximately 1 wt. percent boric acid.

11. A cementitious composition consisting of water and a dry component mixture of mono ammonium hydrogen phosphate, magnesium oxide and silicate fibers.

12. The composition of claim 11, further including boric acid.

13. The composition of claim 11, said dry component mixture consisting of approximately 40 to 90 wt. percent magnesium oxide, approximately 30 to 5 wt. percent mono ammonium hydrogen phosphate, and approximately 30 to 5 wt. percent silicate fibers.

14. The composition of claim 13, said silicate fibers being aluminum silicate fibers.

15. The composition of claim 13, said silicate fibers being calcium silicate fibers.

16. The composition of claim 11, said dry component mixture consisting of approximately 60 wt. percent magnesium oxide, approximately 15 wt. percent mono ammonium hydrogen phosphate, and approximately 25 wt. percent silicate fibers.

17. The composition of claim 12, said dry component mixture consisting of approximately 40 to 90 wt. percent magnesium oxide, approximately 30 to 5 wt. percent mono ammonium hydrogen phosphate, approximately 30 to 5 wt. percent silicate fibers, and less than approximately 1.5 wt. percent boric acid.

18. The composition of claim 17, said silicate fibers being aluminum silicate fibers.

19. The composition of claim 17, said silicate fibers being calcium silicate fibers.

20. The composition of claim 12, said dry component mixture consisting of approximately 60 wt. percent magnesium oxide, approximately 15 wt. percent mono ammonium hydrogen phosphate, approximately 24 wt. percent silicate fibers, and approximately 1 wt. percent boric acid.
